(19) United States
(12) Patent Application Publication
(10) Pub. No.: US 2021/0292498 A1
(43) Pub. Date: Sep. 23, 2021

(54) High-strength carbon fiber composite bar material with resin rib on surface and preparation method therefor

(71) Applicant: FASTEN HONGSHENG GROUP CO., LTD., Jiangyin, Jiangsu (CN)

(72) Inventors: Lihua LIU, Jiangyin, Jiangsu (CN); Yuanlin ZHU, Jiangyin, Jiangsu (CN); Weijun ZHU, Jiangyin, Jiangsu (CN); Jiaqi ZHOU, Jiangyin, Jiangsu (CN); Shengbin HUANG, Jiangyin, Jiangsu (CN)

(73) Assignee: FASTEN HONGSHENG GROUP CO., LTD., Jiangyin, Jiangsu (CN)

(21) Appl. No.: 17/257,589

(22) PCT Filed: Jun. 29, 2019
(86) PCT No.: PCT/CN2019/093940

§ 371 Date: Jan. 4, 2021

(30) Foreign Application Priority Data
Jul. 4, 2018 (CN) 201810725391.1

(51) Int. Cl. C08J 5/24; B29C 70/16; B29C 70/34; B29C 70/56

(52) U.S. Cl. CPC C08J 5/243; B29C 70/16; B29K 2063/00; B29C 70/56; C08J 2363/00; B29C 70/345

(57) ABSTRACT

The invention belongs to the technical field of building materials, mainly relates to a high-strength carbon fiber composite bar with resin ribs on the surface, and a preparation method thereof. The invention comprises a carbon fiber and an epoxy resin matrix, wherein continuous spiral epoxy resin ribs are arranged on the surface of the bar, the thickness of the resin ribs is within 0.2 mm-0.4 mm, the width of the resin ribs is within 5 mm-7 mm, and the pitch of the resin rib is within 2 mm-4 mm. According to the present invention, during the forming process, the nylon belt winding of the present application does not squeeze the carbon fiber bundle, and due to tension of the carbon fiber bundle, the carbon fiber bundle remains straight along the lengthwise direction of the bar. Therefore, the bar manufactured by the method of the present invention has the characteristics of high strength and high modulus.

### TECHNICAL FIELD

The invention belongs to the technical field of building materials, mainly relating a high-strength carbon fiber composite bar with resin ribs on the surface, and a preparation method of the high-strength carbon fiber composite bar with resin ribs on the surface.

### BACKGROUND ART

The carbon fiber composite bar has the advantages of light weight, high strength, corrosion resistance, fatigue resistance, and sound shock absorption, and it is used as a cable component in bridge cables, which has become a development direction to improve bridge span and durability. However, a plain round carbon fiber composite bar is difficult to anchor, which represents a key factor that restricts a wide application of bars application currently. At present, three carbon fiber composite bars with ribs on the surface are developed at home and abroad, and are used to increase the mechanical interaction between a bar surface and an anchoring material, thus to improve the anchoring efficiency of the bar.

A first method is as follows: producing a plaint round carbon fiber composite bar through a pultrusion process, preparing fiber bundles and dipping them in epoxy resin and then winding the surface of the plaint round carbon fiber composite bar with the fiber bundle dipping in epoxy resin, and curing the epoxy resin and making it bonding on the plaint round carbon fiber composite bar to ribs. The fiber bundle of the ribbed bar produced by this method has a low bonding strength to the plain round bar and it is prone to debond, so the tensile property of the carbon fiber composite bar is not fully exerted.

A second method is as follows: winding a F4 belt around an uncured preformed bar impregnated with epoxy resin, and then pulling it into a forming mold for curing; after curing, unwinding the F4 belt to form a spiral groove on the bar surface. This method has two problems: the first, due to winding of the F4 belt, the internal continuous carbon fiber bundles fluctuate in a lengthwise direction of the bar, resulting in a substantial decrease in tensile strength and elastic modulus of the bar; the second, after the F4 belt is wound, the bar surface becomes uneven and a large friction force is produced when it is pulled into the forming mold for curing, which may cause mold blocking. Subjected to an experimental test, the bar produced by the method has the a tensile strength of about 2400 MPa, and a tensile modulus of about 150 GPa.

A third method is to form a threaded structure on the bar surface of the bar through a mechanical method. This method cuts off the carbon fiber bundles on the bar surface, which may affect the tensile strength and stiffness of the bar, thereby wasting material to some extent.

### DETAILED DESCRIPTIONS OF THE INVENTION

To overcome the above disadvantages, the present invention designs a high-strength carbon fiber composite bar with resin ribs on the surface and a preparation method thereof, wherein the preparation method has the advantages of one-time forming, simple process and it can avoids mold blocking; the high-strength carbon fiber composite bar with epoxy resin ribs on the surface produced has continuous spiral epoxy resin ribs on the surface and has the characteristics of easy anchoring, high strength and high modulus.

The purpose of the present invention is achieved by the following: a high-strength carbon fiber composite bar with resin ribs on the surface, comprising a carbon fiber and an epoxy resin matrix, wherein continuous spiral epoxy resin ribs are arranged on the surface of the bar, the thickness of the resin ribs is within 0.2 mm-0.4 mm, the width of the resin ribs is within 5 mm-7 mm, and the pitch of the resin rib is within 2 mm-4 mm.

A preparation method of the high-strength carbon fiber composite bar with resin ribs on the surface is described as follows:

Step 1. Introducing a plurality of carbon fiber bundles from a creel, adjusting the number of carbon fiber bundles as needed according to the diameter of the bars produced, based on the number of carbon fiber bundles, controlling adjustment of a fiber volume content in a range of 70%-78% and adjustment of a speed within a range of 300 mm/min-600 mm/min, controlling the tension of a cable with a tension controller, and taking a tension adjustment range of 5.88N-9.80N so as to ensure that the orientation of the carbon fiber bundles remains straight during immersion.

Step 2. Pulling the carbon fiber bundle into an epoxy resin tank to impregnate the epoxy resin, entering the preformed mold (after getting out of the epoxy resin tank), extruding the excess epoxy resin to obtain a bar blank with a predetermined size while ensuring the inner diameter of the preformed mold is adjusted within the range of 2 mm-10 mm, the epoxy resin is made of a resin matrix, a curing agent and a catalyst, with a mass ratio of 1000:860:13.6;

Step 3. When pulling the bar blank forward, winding a nylon tapes on the bar blank while keeping the winding distance of the nylon belt within 5 mm-7 mm, controlling the winding tension to ensure that the nylon belt is only attached to the surface of the bar blank and the bar blank is not tightened, the orientation of the carbon fiber bundle on the surface of the bar blank remains straight without fluctuation, the width of the nylon belt is 2 mm-4 mm, and the thickness thereof is 0.5 mm-1 mm;

Step 4. Pulling the bar blank with a nylon belt on the surface through 5 ovens successively, with the temperature of the 5 ovens set to 150° C., 150° C., 160° C., 180° C., 180° C.; after being heated by the first oven, the epoxy resin inside the bar blank expands when heated and keeps a good fluidity, starts to overflow from the inside of the bar blank and gradually fills up the gap between the nylon tapes; after the second oven, the epoxy resin gels; after the third oven, the epoxy resin is pre-cured, after the last two ovens, it completes the post-curing process, and the thickness of the resin rib is affected by the preheating time which is controlled by controlling a length of the first oven.

Step 5. After the curing is completed, unwinding the nylon tapes on the surface of the bar, then a spiral resin rib is formed by the epoxy resin in the gap of the nylon tapes, and a spiral groove is formed at the unwinding part of the nylon tapes.

Step 6: Winding the resin bars produced on a take-up machine after being pulled by a puller.

Compared with the prior art, the invention has the advantages that:

1. The bar surface has continuous spiral epoxy resin ribs, the epoxy resin ribs and the epoxy resin matrix in the bar are integrally formed, and there is a high bonding strength between the two, so it is not prone to debonding. After being anchored by an epoxy resin bonding anchor system, an epoxy resin anchoring material and the epoxy resin rib on the bar surface form a mechanical interaction, which greatly improves the anchoring effect.

2. During the forming process, the nylon belt winding of the present application does not squeeze the carbon fiber bundle, and due to tension of the carbon fiber bundle, the carbon fiber bundle remains straight along the lengthwise direction of the bar. Different from a previous production process which uses the nylon belt to wind the bar to form a tightened sign, this invention solves the defects of the compression of the nylon belt against the surface carbon fiber and the damage on the flatness of the carbon fiber. Therefore, the bar manufactured by the method of the present invention has the characteristics of high strength and high modulus. Subjected to an experimental test, the bar produced by the method of the present invention has a tensile strength of about 3300 MPa, and a tensile modulus of about 170 GPa.

3. The method of the present invention has the characteristics of integral molding and simple process.

### DESCRIPTION OF THE DRAWINGS

FIG. 1 depicts a structural diagram of a high-strength carbon fiber composite bar with resin ribs on the surface of the present invention.

FIG. 2 depicts a process flow diagram of a preparation method of the high-strength carbon fiber composite bar with resin ribs on the surface of the present invention

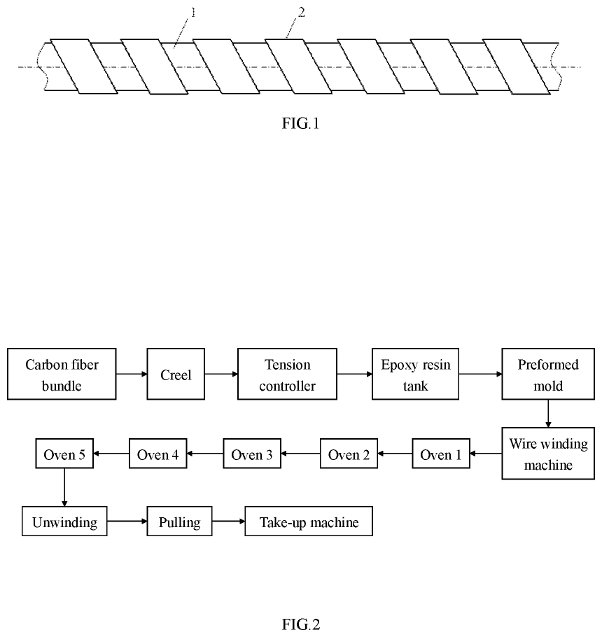

Wherein,

1—Carbon fiber composite bar, 2—Resin rib.

### DETAILED DESCRIPTION OF EMBODIMENTS

In combination with the attached drawings and embodiments, the present invention is further described in details.

The technical solutions of the embodiments described below with reference to the drawings are clearly and completely described, obviously, the embodiments illustrated only constitute a part of the embodiments of the present invention, but not covering all. Based on the embodiments of the present invention, all other embodiments obtained by ordinary technicians skilled in the art without any creative work shall fall within the protection scope of the present invention.

### Embodiment I

A high-strength carbon fiber composite bar with resin ribs on the surface, comprising a carbon fiber and an epoxy resin matrix, wherein the bar diameter is 7 mm, the bar surface has continuous spiral epoxy resin ribs, the thickness of the resin rib is 0.25 mm, and the pitch of the resin rib is 2.4 mm.

A method for preparing high-strength carbon fiber composite bar with resin ribs on the surface comprises the following steps:

Step 1. Introducing 62 carbon fiber bundles from a creel at a speed of 350 mm/min, controlling the cable tension at 6.88N with a tension controller;

Step 2. Pulling the carbon fiber bundle into an epoxy resin tank to impregnate the epoxy resin, entering the preformed mold (after getting out of the epoxy resin tank), extruding the excess epoxy resin to obtain a bar blank with an inner diameter of 7 mm while ensuring the inner diameter of the preformed mold is 7 mm, the fiber volume content of the bar blank is 72%, the epoxy resin is made of a resin matrix, a curing agent and a catalyst, with a mass ratio of 1000:860:13.6;

Step 3: When pulling the bar forward, winding a nylon belt on the bar blank while keeping the winding distance of the nylon belt at 6.3 mm, controlling the winding tension to ensure that the nylon belt is only attached to the surface of the bar blank and the bar blank is not tightened, the orientation of the carbon fiber bundle on the surface of the bar blank remains straight, carbon fiber bundle is not stressed by the nylon belt, without fluctuation, the width of the nylon belt is 2.5 mm, and the thickness thereof is 0.7 mm;

Step 4. Pulling the bar blank with a nylon belt on the surface through 5 ovens successively at a speed of 250-600 mm/min, with the temperature of the 5 ovens set to 150° C., 150° C., 160° C., 180° C., 180° C.; after being heated by the first oven, the epoxy resin inside the bar blank expands when heated and keeps a good fluidity, starts to overflow from the inside of the bar blank and gradually fills up the gap between the nylon tapes; after the second oven, the epoxy resin gels; after the third oven, the epoxy resin is pre-cured, after the last two ovens, it completes the post-curing process, and the thickness of the resin rib is affected by the preheating time which is controlled by controlling a length of the first oven; the length of the first oven of the present application is set as 3-7 m, and the oven supports heating in stages, thus to adjust the actual length of the oven.

Step 5. After the curing is completed, unwinding the nylon tapes on the surface of the bar, then a spiral resin rib is formed by the epoxy resin in the gap of the nylon taps, and a spiral groove is formed at the unwinding part of the nylon tapes.

Step 6. Winding the resin bars produced on a take-up machine after being pulled by a puller; the tensile strength and tensile modulus of the resin bars are respectively 3436 MPa and 171 GPa.

### Embodiment II

A high-strength carbon fiber composite bar with resin ribs on the surface, comprising a carbon fiber and an epoxy resin matrix, wherein the bar diameter is 5 mm, the bar surface has continuous spiral epoxy resin ribs, the thickness of the resin rib is 0.2 mm, and the pitch of the resin rib is 2 mm.

A method for preparing high-strength carbon fiber composite bar with resin ribs on the surface comprises the following steps:

Step 1. Introducing 32 carbon fiber bundles from a creel at a speed of 450 mm/min, controlling the cable tension at 6.2N with a tension controller;

Step 2. Pulling the carbon fiber bundle into an epoxy resin tank to impregnate the epoxy resin, entering the preformed mold (after getting out of the epoxy resin tank), extruding the excess epoxy resin to obtain a bar blank with a 5 mm diameter while ensuring the inner diameter of the preformed mold is 5 mm, the fiber volume content of the bar blank is 75%, the epoxy resin is made of a resin matrix, a curing agent and a catalyst, with a mass ratio of 1000:860:13.6;

Step 3. When pulling the bar forward, winding a nylon belt on the bar blank while keeping the winding distance of the nylon belt at 5.2 mm, controlling the winding tension to ensure that the nylon belt is only attached to the surface of the bar blank and the bar blank is not tightened, the orientation of the carbon fiber bundle on the surface of the bar blank remains straight without fluctuation, the width of the nylon belt is 2 mm, and the thickness thereof is 0.5 mm;

Step 4. Pulling the bar blank with a nylon belt on the surface through 5 ovens successively at a speed of 400 mm/min, with the temperature of the 5 ovens set to 150° C., 150° C., 160° C., 180° C., 180° C.; after being heated by the first oven, the epoxy resin inside the bar blank expands when heated and keeps a good fluidity, starts to overflow from the inside of the bar blank and gradually fills up the gap between the nylon tapes; after the second oven, the epoxy resin gels; after the third oven, the epoxy resin is pre-cured, after the last two ovens, it completes the post-curing process, the length of the first oven described in the embodiment is 4 mm.

Step 5. After the curing is completed, unwinding the nylon tapes on the surface of the bar, then a spiral resin rib is formed by the epoxy resin in the gap of the nylon taps, and a spiral groove is formed at the unwinding part of the nylon tapes.

Step 6. Winding the resin bars produced on a take-up machine after being pulled by a puller; the tensile strength and tensile modulus of the resin bars are respectively 3560 MPa and 174 GPa.

The curing agent of the present application is selected from menthane diamine (MDA) and aromatic amines, wherein the aromatic amine may be m-XDA, which has an HDT temperature of 130-150° C. and a high expansion coefficient. The catalyst may be an amine-based anionic catalyst, inorganic salt, inorganic base, including calcium chloride, lithium hydroxide, etc. It includes but not limited to the said materials.

The preferred embodiments of the present invention disclosed above are only indented to help explain the present invention. The preferred embodiments do not described in all full details, and they do not limit that the invention only covers the said embodiments. Obviously, many modifications and changes can be made according to the content of the specification. The specification selects these embodiments and gives detailed descriptions of them in order to better explain the principles and practical applications of the present invention, thereby those skilled in the art can understand and use the present invention well. The present invention is only limited by the claims and the full scope, as well as equivalents.

1. A high-strength carbon fiber composite bar with resin ribs on the surface, comprising carbon fibers and epoxy resin matrix, wherein the composite bar is characterized in that: there are continuous spiral epoxy resin ribs on the surface of the said bar matrix.

2. A high-strength carbon fiber composite bar with resin ribs on the surface of claim 1, wherein the composite bar is characterized in that the thickness of the resin rib is in a range of 0.2 mm-0.4 mm, and the width of the resin rib is in a range of 5 mm-7 mm, and the spiral pitch of the resin rib is in a range of 2 mm-4 mm.

3. A preparation method of a high-strength carbon fiber composite bar with resin ribs on the surface of claim 1, which is characterized by comprising the following steps:
Step 1, drawing a plurality of carbon fiber bundles from a creel, adjusting the number of carbon fiber bundles as needed according to the diameter of the bar; through the number of fiber bundles, controlling a volume content of the carbon fibers in the bar blank to be in a range of 70%-78%, adjusting a drawing speed in a range of 300 mm/min-600 mm/min, controlling a tension with a tension controller, adjusting the tension in a range of 5.88 N-9.80 N;
Step 2, pulling the carbon fiber bundles into an epoxy resin tank so that the carbon fiber bundles are impregnated with the epoxy resin; after moving out of the epoxy resin tank, putting into a preformed mold to obtain a bar blank with a predetermined diameter, wherein an inner diameter of the preformed mold is in a range of 2 mm-10 mm;
Step 3, when pulling the bar blank forward, winding a nylon belt on the bar blank, controlling the winding tension to ensure that the nylon belt is attached to the surface of the bar blank but not tightening the bar blank, the orientation of the carbon fiber bundles on the surface of the bar blank remains straight, the width of the nylon belt is 2 mm-4 mm, and the thickness thereof is 0.5 mm-1 mm;
Step 4, pulling the bar blank with the nylon belt on the surface through 5 ovens successively, wherein the temperatures of the 5 ovens are set to be 150° C., 150° C., 160° C., 180° C., 180° C.; after heated by the first oven, the epoxy resin inside the bar blank expands and has a good fluidity, starts to overflow from the inside of the bar blank and gradually fills up the gaps of the nylon belt; after treatment in the second oven, the epoxy resin gels; after treatment in the third oven, the epoxy resin is pre-cured; after the last two ovens, a post-curing process is completed;
Step 5, after the curing is completed, unwinding the nylon belt from the surface of the bar, then spiral resin ribs are formed by the epoxy resin overflowing in the gaps of the nylon belt, and spiral grooves are formed at the unwinding part of the nylon belt.
Step 6, winding the produced bars with resin ribs on a take-up machine after being pulled by a puller.

4. A preparation method of a high-strength carbon fiber composite bar with resin ribs on the surface of claim 3, wherein the preparation method is characterized in that the epoxy resin in Step 2 comprises a resin matrix, a curing agent and a catalyst, with a mass ratio of 1000:860:13.6.
